(19) United States
(12) Patent Application Publication
(10) Pub. No.: US 2019/0065973 A1
(43) Pub. Date: Feb. 28, 2019

(54) Method for Internet-of-things based, preventive maintenance of industrial equipment using an expert system

(71) Applicant: Mostafa Abdelrahman Mahmoud Elwakeel, Giza (EG)

(72) Inventor: Mostafa Abdelrahman Mahmoud Elwakeel, Giza (EG)

(21) Appl. No.: 15/687,482

(22) Filed: Aug. 27, 2017

(51) Int. Cl. G06N 5/04; H04L 29/08

(52) U.S. Cl. CPC G06N 5/045; H04L 67/12

(57) ABSTRACT

A customized, real time equipment monitoring system observes external conditions and critical parameters of any simple or sophisticated system and provides automatic assistance in decision-making using a set of expert rules abstracted from previous experience as well as predicted data collected from an Internet of things environment.

### TECHNICAL FIELD

This invention concerns a customized, embedded system based, real time equipment monitoring system using Internet-of-things technology designed to be an advanced tool for preventive maintenance, prediction, data logging and decision making in the following medical and industrial application environments:
1. Medical Equipment (MRI, CT, X-ray, PET-CT, etc)
2. Healthcare facilities& Blood banks.
3. Pharmaceutical industries.
4. Food industries.
5. Environmental Data Acquisition and Studies
6. HVAC Systems.
7. Data Centers.
8. Smart buildings and smart cities.

It monitors external conditions and critical parameters of any simple or sophisticated system and provides automatic assistance in decision making using a set of expert rules abstracted from previous experience as well as predicted data collected from an Internet of things environment. Three types of parameters can be monitored in this context:

### 1—Sensor Data:

Any types of sensors can be interfaced through a hardware & software customization process.

Examples of supported sensors:
Environmental sensors: All types of temperature sensors, humidity, air quality, smoke, IR thermometer. Thermocouples, motion detectors.
Acoustic sensors: Noise level, microphone, vibration.
Chemical sensors:pH₂Oxygen, NH3, N2O, Co2, Co.
Magnetic sensors: Hall Effect, Electric field.
Position and distance sensors: Linear encoder, rotary encoder, ultrasonic distance.
Optical and light sensors: Lux sensor, spectrometers, photodiodes.
Radiation sensor: X ray detectors, Electromagnetic field detectors.
Pressure sensors: Air pressure, differential pressure.

### 2—Power and Grounding Data:

The system has a specific module for measuring power and grounding data for all electric parameters needed in industrial facilities.

Those Parameters are:
Three phase voltage, current, ground current, neutral to earth voltage.
Electrical power and power factor.
Voltage imbalance, frequency, phase sequence.
Power Quality events according to IEEEStd 1159™-2009.
Insulation resistance.
Line Isolation Monitoring.
Loop impedance (Line to protective Earth L-PE), earth resistance, and line impedance for three phase.

### 3—Selected Data:

The system can be customized to monitor specific parts or sub systems inside the modality like monitoring pumps, chillers, valves or special actuators based on a specific need. It has also the capability to do some custom control functions like the control of valve or motor to respond to certain conditions.

Values of all the above-mentioned parameters are pushed to the Internet through 3G or ADSL. An Internet-of-things application monitors the parameters, predicts upcoming crucial events (especially extreme weather conditions) gives users SMS and email notification if deemed necessary. Users can go to a Website to see the status of the parameters and manually take an action. The Website has also some statistical tools for data analysis in customized report formats to help express and print out queries. In addition to that: A set of rules, abstracted from previous maintenance cases, and forming an expert system, is availed to allow assistance of human decision making. Results of expert advice are also sent via SMS and Email. The overall system is equipped with a large external battery so that it can survive for 5 hours if the main power is cut off for any reason. FIG. 1 shows the overall systems logical diagram.

### BACKGROUND ART

Known are real-time automobile analog-to-digital sampling monitoring devices [patent publication number: CN204129803 (U)], comprised of a micro processor, an analog-to-digital conversion device, a wireless communication device and a power supply device, wherein the micro processor is connected with the analog-to-digital conversion device and the wireless communication device; the power supply device is connected with the micro processor and the wireless communication device. The device not only can provide automobile analog-to-digital sampling data, but also can send the automobile analog-to-digital sampling data to a monitoring server in real time so as to achieve the aim of monitoring automobile information in real time.

Known are analog sampling circuits of a wind power variable propeller motor measurement device [patent publication number: CN103166608 (A)]. The circuit comprises a comparator, and the comparator samples sine values of a rotary transformer and cosine values of the rotary transformer. A filter circuit is additionally arranged, and comprises a first filter circuit, a second filter circuit and a third filter circuit, wherein the first filter circuit filters the sampled sine values and the sampled cosine values, the second filter circuit filters comparison voltages of the comparator, and the third filter circuit filters output voltages. This analog sampling circuit has the advantage of effectively filtering to ensure that sampled analog signals are more accurate

Known are analog-sampling and specification-generating devices which comprise four function parts [patent publication number: CN201928264 (U)]: A main control computer, a management module, an analog signal processing module and a digital signal processing module i.e. a specification-generating module. They consist of the main control computer, the management module, an analog signal modulating unit, an ADC (analog to digital convertor) sampling module and a signal processing module, wherein the analog signal modulating module outputs an analog signal meeting the requirements of the ADC sampling module, the analog signal accesses the ADC sampling module, the ADC sampling module outputs a digital signal, and the digital signal serially accesses the signal processing module; and the signal processing module outputs the corrected digital signal, one path of the digital signal accesses a checked meter with a network output optical fiber through framing, the other path of the digital signal accesses the management module through a serial communication wire, and six paths of ADC sampling chips are started when the signal processing module outputs a same trigger signal. With the adoption of this invention, a bridge between an analog metering standard and a digital input type watt-hour meter is established, and the electric power of an indoor-installation type digital watt-hour meter which follows protocols of DL/T860-9-1/2 and IEC61850-9-1/2LE can trace to the source of a national standard

Known are electronic devices for sampling an analog signal by varying the propagation time [patent publication number: WO/2010/029275] to avoid the following problem: the moment when a sample is captured coincides with the moment when diodes are subjected to a strong electrical conduction that promotes the appearance of noise insofar as the diodes carry short current. Those devices intend to solve the stated problems by doing away with the use of diodes. Consequently, the devices are capable of being used for sampling in real-time and for sub sampling. It has the advantage of neither being constrained by the noise nor by the speed limitations inherent in the diodes. The operating principle thereof rests on using the wave propagation time on a nonlinear waveguide. Known are devices adapted to sample and amplify with an optimum gain multiplexed analog signals [patent publication number: U.S. Pat. No. 4,378,527 A]. They are comprised of a chain of three interconnected amplifiers, the first of which has a gain of unity, the respective gains of the two others being selected in dependence on their output voltage as compared to a reference voltage. The devices also comprise three memorizing capacitors each of which is adapted to memorize the output voltage of a corresponding amplifier, and switches, actuated in accordance with the gain selection for each amplifier, to make the necessary connections for operating the chain of amplifiers with the selected gain Known are also large medical equipment monitoring and early warning devices [patent publication number: CN204044983 (U)] The utility model relates to medical equipment safety detection devices, in particular to a large medical equipment monitoring and early warning device. The large medical equipment monitoring and early warning device comprises a current sensing module, a temperature detection module, a humidity detection module, a water leakage probing module and a wind sensing switch module. The current sensing module is connected to a signal acquisition end of a control circuit through a relay. A signal output end of the control circuit is connected to a GSM communication module and a sound and light alarm circuit. The control circuit adopts an integrated circuit with a model of STM32F103. According to the utility model, the temperature, humidity and pounding among equipment, the equipment cabinet heat dissipating fan running and the working status of a 24-hour running master device are detected and monitored; and if anything abnormal occurs, a relevant alarm is started, alarm information is sent to an equipment person in charge or maintenance person in charge so that preventive maintenance measures are taken in time, and the large medical equipment monitoring and early warning device has great significance in reducing the failure rate of large equipment and improving the utilization efficiency and economic benefits.

Known is a smart multi-dimensional big data analyzing expert system for high-voltage circuit breaker in a power grid [patent publication number: PCT/CN2015/083822] The system comprises a circuit breaker cluster cloud database and a smart expert decision terminal. The circuit breaker cluster database comprises a real-time circuit breaker monitoring database, a technical circuit breaker monitoring database, a circuit breaker security risk technical indicator database and a circuit breaker warehouse inventory database. The smart expert decision terminal comprises a device security risk evaluation module, an optimal device maintenance solution ranking module and a mobile terminal online dynamic warning module. The circuit breaker cluster database dynamically acquires data, and the smart expert decision terminal performs history data analysis, trend analysis, variable analysis, comparison analysis and factor analysis on the acquired data. The system performs, on the basis of big data analysis techniques, multi-dimensional analysis on a vast amount of cloud data online and offline, so as to realize centralized and real-time monitoring and management on a circuit breaker, and provide functions of evaluating a security risk of a circuit breaker state, ranking to obtain an optimal device maintenance solution, providing mobile terminal online dynamic warning, and the like, thus improving a secure and economical level of operation and maintenance of a circuit breaker, and better managing a device life-cycle of the circuit breaker.

Known are systems and methods for diagnosing and validating a machine over a network using waveform data [patent publication number: EP 1197861 A2]. Historical waveform data are obtained via the network from machines having known faults along with corresponding actions for repairing the machines and are used to develop fault classification rules. The fault classification rules are stored in a diagnostic knowledge database. The database of classification rules are used to diagnose new waveform data from a machine having an unknown fault, via the network. Fault identification is manually guided. The candidate set of faults generated from the diagnostic unit are presented to a knowledge facilitator, which is a service engineer. The service engineer examines the candidate set and determines if the fault has been correctly identified. If the fault has not been correctly identified, then the service engineer identifies the correct fault type and inputs the new waveform data and fault type information into the training unit so that it can be used to identify future faults of a similar nature. In particular, the waveform data and fault type information are inputted to the training parser for parsing, the training filter, the training feature extractor and the training fault classifier.

Known are Internet-of-things based devices. An Internet-of-things—based simple ventilator having global positioning function is described for example in [patent publication number: WO2016CN77601]. The invention comprises a ventilation component, an air storage component, and a central control device. The ventilation component is connected to the air storage component. The central control device is electrically connected respectively to the ventilation component and the air storage component. The Internet-of-things-based simple ventilator having the global positioning function implements wireless connection to an external smart communication terminal via a wireless communication module to allow a user to monitor in real-time a use state of the apparatus, thus increasing the practicability of the apparatus, implements global positioning via a global positioning module to allow the apparatus to be positioned in real-time by a rescuer and to increase rescue efficiency, thus increasing the practicability of the apparatus, and, at the same time, monitors in real-time the pressures at a pressure safety valve, an oxygen storage valve, and an air storage safety valve via a pressure sensor to prevent the apparatus from being damaged due to excess pressure, thus increasing the reliability of the apparatus.

Known are Case Based Expert Systems as described for example in [http://wi.cs.uni-frankfurt.de/webdav/publications/2009_KI_CBR.pdf]. In a nutshell, Case Based Reasoning (CBR) is reasoning by remembering: previously solved problems (cases) are used to suggest solutions for novel but similar problems. There are four assumptions about the world around us that represent the basis of the CBR approach: 1. Regularity: the same actions executed under the same conditions will tend to have the same or similar outcomes. 2. Typicality: experiences tend to repeat themselves. 3. Consistency: small changes in the situation require merely small changes in the interpretation and in the solution. 4. Adaptability: when things repeat, the differences tend to be small, and the small differences are easy to compensate for. FIG. 2 illustrates how the assumptions listed above are used to solve problems in CBR [https://ibug.doc.ic.ac.uk/media/uploads/documents/courses/syllabus-CBR.pdf]. Once the currently encountered problem is described in terms of previously solved problems, the most similar solved problem can be found. The solution to this problem might be directly applicable to the current problem but, usually, some adaptation is required. The adaptation will be based upon the differences between the current problem and the problem that served to retrieve the solution. Once the solution to the new problem has been verified as correct, a link between it and the description of the problem will be created and this additional problem solution pair (case) will be used to solve new problems in the future. Adding of new cases will improve results of a CBR system by filling the problem space more densely.

Not known are methods in which a customized, real time preventive maintenance system of industrial equipments is connected to a set of expert, CBR enabled Internet-of-things services and designed to be an advanced tool for equipment maintenance, prediction, data logging and real time decision making in all sorts of application environments. The system monitors external conditions and critical parameters of any simple or sophisticated medical setting, foresees using Internet-of-things technologies upcoming crucial events and decides to take preventive action according to a set of Case Based Expert Rules (CBERs) abstracted from previous experience.

### GOAL OF THE INVENTION

The objective of this invention is to optimize maintenance decisions taken in the context of industrial, preventive equipment monitoring as well as arbitrary tele-monitoring systems for critical parameters in the most general and complete way, utilizing CBR expert logic conditions deduced from past experiences and predicted event information.

### Discussion of the Nature of the Invention

The invention is based on the objective of creating a method of the type mentioned above which optimizes maintenance decisions of industrial equipments in the most general and complete form and in such a way that the response procedure uses CBR to achieve solutions for newly encountered problems using previous experience as well as predicted information. This object is achieved by method steps described in the Patent claims 1-9.

### Example of Accomplishment

### Monitoring Activities and CBR

The process underlying the current invention is based upon the idea of constructing solution pairs (cases) from collected equipment data and performed maintenance activities. In general, three main approaches to case-base organization can be distinguished: flat organization, clustered organization, and hierarchical organization. Also a combination of these methods within the same case base is possible. Flat organization is the simplest case-base organization that yields a straightforward flat structure of the case base. Though advantageous due to its simplicity and facile case addition/deletion, a flat case-base organization imposes, in general, case retrieval based upon a case-by-case search of the whole case base. Hence, for medium and large case bases, this leads to time-consuming retrieval, yielding an inefficient CBR system. Clustered organization, originating in the dynamic memory model initially proposed by Schank [R. C. Schank, Dynamic memory: A theory of reminding and learning in computers and people. Cambridge, UK: Cambridge University Press, 1982.], is the type of case-base organization in which cases are stored in clusters of similar cases. The grouping of cases may be based on their mutual similarity (like in the case of the dynamic memory of experiences used by Pantic [M. Pantic, Facial Expression Analysis by Computational Intelligence Techniques. PhD thesis, Delft University of Technology, 2001], [M. Pantic and L. J. M. Rothkrantz, “Case-based reasoning for user-profiled recognition of emotions from face images”, Proc. IEEE Int'l Conf. Multimedia and Expo, 2004.]) or on the similarity to some prototypical cases. The advantage of this organization is that the selection of the clusters to be matched is rather easy, as it is based upon the indexes and/or prototypical cases characterizing the clusters. A disadvantage is that it needs a more complex algorithm for case addition/deletion than a flat organized case base. Hierarchical organization, originating in the category-exemplar memory model of Porter and Bareiss [B. W. Porter and E. R. Bareiss, “PROTOS: Experiment in knowledge acquisition for heuristic classification tasks”, Proc. 1st Int'l Meeting on Advances in Learning, pp. 159-174, 1986], is the case-base organization that is generally obtained when cases that share the same features are grouped together. The case memory is a network structure of categories, semantic relations, cases, and index pointers. Each case is associated with a category, while the categories are inter-linked within a semantic network containing the features and intermediate states referred to by other terms. Different case features are assigned different importance in describing the membership of a case to a category. It must be noted that this importance assignment is static; if it changes, the case-base hierarchy has to be redefined. A new case is stored by searching for a matching case and by establishing the relevant feature indexes. If a case is found with only minor differences to the new case, the new case is usually not retained. In turn, a hierarchical case-base organization facilitates fast and accurate case retrieval. However, its higher complexity implies a rather cumbersome case addition/deletion, potentially involving expensive case-base reorganization and an inapt case base evaluation and maintenance. In this invention flat case-based organization is adopted.

Given a description of a problem, a retrieval algorithm should retrieve cases that are most similar to the problem or situation currently presented to the pertinent CBR system. The retrieval algorithm relies on the indices and the organization of the case memory to direct the search to case(s) potentially useful for solving the currently encountered problem. The issue of choosing the best matching cases can be referred to as analogy drawing, that is, comparing cases in order to determine the degree of similarity between them. Many retrieval algorithms have been proposed in the literature up to date: induction search (e.g., ID3, [J. R. Quinlan, Programs for Machine Learning. San Mateo, USA: Morgan Kaufmann, 1993.]), nearest neighbor search, serial search, hierarchical search, parallel search, etc. (for examples, see [T. M. Mitchell, Machine Learning. Singapore: McGraw-Hill Companies Inc., 1997.]). The simplest form of retrieval is the kst-nearest-neighbor search of the case base, which performs similarity matching on all the cases in the case base and returns just one best match [T. M. Mitchell, Machine Learning. Singapore: McGraw-Hill Companies Inc., 1997.]. Nearest-neighbor retrieval is a simple approach that computes the similarity between stored cases and new input case based on weight features. A typical evaluation function is used to compute nearest-neighbor matching as shown in FIG. 3. Where wᵢ is the importance weight of a feature, sim is the similarity function of features, and fᵢ^{l} and fᵢ^{R} are the values for feature i in the input and retrieved cases respectively. FIG. 4 displays a simple scheme for nearest-neighbor matching. In this 2-dimensional space, case3 is selected as the nearest neighbor because similarity(NC, case3)>similarity(NC, case1) and similarity(NC, case3)>similarity(NC, case2). This invention uses nearest-neighbor retrieval algorithms to find cases similar to the produced, new ones.

Generally, once a matching case is retrieved, it will not correspond to exactly the same problem as the problem for which the solution is currently being sought. Consequently, the solution belonging to the retrieved case may not be optimal for the problem presently encountered and, therefore, it should be adapted. Adaptation looks for prominent differences between the retrieved case and the current case, and then (most commonly) applies a formulae or a set of rules to account for those differences when suggesting a solution. In general, there are two kinds of adaptation in CBR [I. Watson and F. Marir, “Case-base reasoning: A review”, The Knowledge Engineering Review, vol. 9, no. 4, pp. 327-354, 1994.]: 1. Structural adaptation applies adaptation rules directly to the solution stored in cases. If the solution comprises a single value or a collection of independent values, structural adaptation can include modifying certain parameters in the appropriate direction, interpolating between several retrieved cases, voting, etc. However, if there are interdependencies between the components of the solution, structural adaptation requires a thorough comprehension and a well-defined model of the problem domain. 2. Derivational adaptation reuses algorithms, methods, or rules that generated the original solution to produce a new solution to the problem currently presented to the system. Hence, derivational adaptation requires the planning sequence that begot a solution to be stored in memory along with that solution. This kind of adaptation, sometimes referred to as reinstantiation, can only be used for problem domains that are well understood. An ideal set of rules must be able to generate complete solutions from scratch, and an effective and efficient CBR system may need both structural adaptation rules to adapt poorly understood solutions and derivational mechanisms to adapt solutions of cases that are well understood. However, one should be aware that complex adaptation procedures make the system more complex but not necessarily more powerful. Complex adaptation procedures make it more difficult to build and maintain CBR systems and may also reduce system reliability and, in turn, user's confidence in the system if faulty adaptations are encountered due to, for example, incompleteness of the adaptation knowledge, which is the most difficult kind of knowledge to acquire [W. Mark, E. Simoudis and D. Hinkle, “Case-based reasoning: Expectations and results”, Case-Based Reasoning: Experiences, Lessons & Future Directions, D. B. Leake, (Ed.), pp. 269-294, AAAI Press, Menlo Park, USA, 1996]. Therefore, in many CBR systems, adaptation is done by the user rather than by the system. Mark et al. report that in a well-designed system, the users do not perceive “manual” adaptation as something negative [W. Mark, E. Simoudis and D. Hinkle, “Case-based reasoning: Expectations and results”, Case-Based Reasoning: Experiences, Lessons & Future Directions, D. B. Leake, (Ed.), pp. 269-294, AAAI Press, Menlo Park, USA, 1996.]. This invention adopts a structural adaptation algorithm using simple parameter-value substitution as shall be seen below.

### Formalism

An expert system of the kind this invention is adopting may be best described and formulated in mathematical logics using horn programs (see [http://www.cs.toronto.edu/˜sheila/2502/f06/slides/05.HornLogic.pdf] for a quick introduction).The following definitions serve in doing that.

### Definition-1: Horn Clauses

A clause (i.e., a disjunction of occurrences of variables which are called literals) is called a Horn clause if it contains at most one positive literal. Horn clauses are usually written as

L₁, . . . ,Lₙ⇒L(≡¬L₁∨ . . . ∨¬Lₙ∨L)

or

L₁, . . . ,Lₙ⇒(≡¬L₁∨ . . . ,∨¬Lₙ),

where n>=0 and L is the only positive literal. A definite clause is a Horn clause that has exactly one positive literal. A Horn clause without a positive literal is called a goal. Horn clauses express a subset of statements of first-order logic. The programming language Prolog is built on top of Horn clauses. Prolog programs are comprised of definite clauses and any question in Prolog is a goal.

### Definition-2: SLD (Selection Function in Linear Resolution for Definite Clauses) Resolution

An SLD derivation of Cₘ from a set {C₁, . . . , Cₙ} of Horn clauses (with the non-negated literal in the first place, if it exists) is a sequence C₁, . . . , Cᵢ, . . . , Cₙ, Cₙ₊₁, . . . , Cₘ such that Cₙ₊₁ is the resolvent of Cᵢ (goal clause) and another C∈{C₁, . . . , Cₙ} for every j>n+1, Cⱼ is the resolvent of Cⱼ₋₁ and another C∈{C₁, . . . , Cₙ}. Every resolution step takes the form:

### L′∨C′, ¬L″∨C″=<(C′∨C″)(MGU(L′,L″))

Where an MGU is an assignment of truth values for literals in L′ and L″ which renders them syntactically equal. SLD resolution is complete for Horn clauses: A set of Horn clauses is unsatisfiable iff there exists an SLD refutation for it. This, as well as efficiency considerations, makes SLD resolution one of the safest ways to perform deductive queries. An Example illustrating SLD Resolution of Horn Clauses is the following:
Let the knowledge-base be KB={CompressorDefect, CompressorDefect ⊃MRINotWorking, MRINotWorking∧PowerShortage⊃ MRINotReparable, MainPowerCut⊃ MRINotWorking, MRINotWorking∨PowerAvailable⊃ MRIReparable, PowerAvailable}, the Goal G={MRIReparable}, then the SLD refutation sequence looks like this: {¬MRIReparable}=>{¬MRINotWorking, ¬PowerAvailable}=>{¬MRINotWorking}=>{¬CompressorDefect}=>[ ]

### Definition-3: CBR Cases

CBR cases are definite clauses wherein the body is called Problem and the unique, positive literal is called Solution. Any predicate, expressed in one or more clauses, in the body is called a Feature. CBR Case Knowledge bases are sets of definite clauses also called Programs.

### Definition-4: Nearest Neighbor Retrieval Algorithm

### Algorithm 1

Inputs: KB, new sought CBR case (C), set of weights of all features used in all CBR cases

Output: Set of pair-wise similar CBR cases

Body: Set MaxSim=0, SelectedCase=First Case in KB

For all CBR cases C′:
Calculate MaxSim=similarity(C,C′) using the formula given in FIG. 3
If the calculated MaxSim is higher than the one stored, replace the one stored and the SelectedCase with C′

### ReturnSelectedCase

### Definition-5: Parameter-Value Substitution Algorithm

### Algorithm 2

Inputs: CBR case (C), Set of Literal mappings of the form M={{L₁>L₂} . . . {Lᵢ>Lⱼ}}

Output:Modified CBR case

Body: For all literals in C:
If {Lₓ>L_{y}} is element of M: Replace Lₓ with L_{y} in C

Finally, an example illustrates best the accomplishment of this invention.

An MRI (Magnetic Resonance imaging) is a medical imaging equipment which depends in its operation on the presence of a powerful magnetic field. The magnetic field strength required by standard diagnostic MRI machines needs excessive electrical current that requires superconductive material. The superconductivity is maintained via massive cooling systems that utilize Helium Liquid Gas (HLG). HLG is kept in a closed cooling loop to transfer heat away from the superconductor magnet. This loop has a powerful helium compressor for the circulation of HLG. If the helium compressor stops due to any malfunction in the system, the HLG starts to evaporate within a few hours resulting in loss of functionality of the whole system. This is considered a severe failure event that cannot be readily addressed taking into consideration the world-wide supply shortage of Helium gas. An MRI Machine is very sensitive to any change in environmental conditions. So it's very critical also to maintain temperature and humidity in specifications levels. Currently: Failure reporting, troubleshooting and maintenance processes are usually performed manually. The time critical aspect of the failure is thus not protected against due to logistical challenges. A simple error can turn into a critical failure if not addressed in a timely fashion. The cost of simple repairs can spiral out of proportions if adequate measures are not taken expeditiously to remedy the situation and prevent the HLG from evaporating. In addition to the loss of the vital medical service provided by the MRI machine.

An example of an environmental condition which can affect a helium compressor of an MRI is overheating. Overheating has a devastating effect on compressors, because:

1. Loss of lubrication film: Refrigeration oils have been highly refined in an effort to elevate the temperature at which chemical decomposition will occur. As such, they are vulnerable to losing the lubrication film necessary to prevent metal-to-metal contact between bearings and journals, or piston rings and cylinders, prior to the temperature at which decomposition begins. With mineral oil this will occur approximately between 310° F. and 330° F. When these temperatures are achieved, the probability of extreme piston and ring wear is imminent.

2. Chemical decomposition: This happens at elevated temperatures, and is accelerated in the presence of other contaminants such as air or water. The rate of chemical reaction doubles with every 18° F. temperature increase. For example, a chemical reaction that takes 10 years to complete at 100° F., will only take 5 years to complete at 118° F. At 136° F. it would be complete in 2-1/2 years, and so forth. The process by which the refrigerant and/or oil chemically breaks down can occur in a matter of seconds if there have been enough 18° temperature increases.

The current invention proposes a solution to the compressor-overheating problem consisting of four parts:
Data Collection
A specially designed extreme weather module lets the system collect sensor readings about weather parameters which may affect the compressor and transfer the data through an Ethernet connection to the Internet. Ethernet or ADSL guarantees 24/7 availability as well as transfer reliability. Data is availed to interested parties in real-time through the Website so that they can manually compare with weather forecasting sites to ensure viability of the information.
Event prediction
An Internet-of-things-based application collects prediction data about selected, crucial parameters (location temperature in this case) from various reliable sources (public weather-forecast services) and compares it to whatever was read through the weather module.
Decision-making using CBR
CBR is immediately engaged when location temperatures reach a threshold level already encountered before and stored in the knowledge base. The stored solution is activated (connected air conditioning devices are adjusted accordingly or MRI maintenance center is informed).
User Alerts
User or System admin is sent a message describing the event and the precautions taken to cope with it

This proposed solution addresses the main aspects that are deficient in the current process:
First, all critical alarms are reported instantaneously; hence corrective measures can be taken accordingly either by connected automatic systems or by supervisors. Not only is the presence of failure reported to the maintenance staff, but the specifics associated with the system fault are also described such that engineers are well informed and prepared to take proper actions in case their intervention is needed.
Second, the operational parameters are continuously reported to the maintenance center such that conditions conducive to cooling system failures can be predicted and prepared for in advance of actual breakdowns.
Third, the system provides visibility and efficiency that was not previously attainable using manual methods. The system provides the means by which a central maintenance operation is established. This central operation ensures all systems are operating at their optimum conditions and that maintenance requests are addressed in order of their severity. More importantly preventive measures can now be taken to prevent catastrophic failures before they actually occur. Logistical difficulties that face maintenance visits are especially compounded due to the congested traffic conditions. The proposed system provides the central maintenance center with the visibility and predictive tools needed to achieve efficiency, customer satisfaction and accordingly a superior medical service to the patients.

### Diagnosis of MRI Compressor Failures—CBR Automatic Response Example

Given: Symptoms e.g. compressor pressure dropped below 285 PSIG
Goal: Find cause for failure e.g. overheating environment or liquid leakage

### I—Example Cases Problem & Features

### Case 1:

Problem: Pressure below 285, above 200
Model: XXX
Year: 1999
Actual current draw: 15.6 A (maximum value)
Status of Electric Service/breaker: OK
Status of light alert: alert
Solution
Diagnosis: Environmental overheat
Repair: Lower air conditioning temperature

### Case 1 (Formalized):

### Model(XXX),

### Y(1999),

### ActualCurrent(15.6),

### ElectricBreaker(ok),

### LightAlert(alert)

[symbol] Environmental Overheat

### Case 2:

Problem: Pressure below 285, above 200
Model: XXXX
Year: 2000
Actual current draw: 10 A (normal)
Status of Electric Service/breaker: OK
State of light alert: OK
Solution
Diagnosis: Liquid leakage
Repair: Replacement of casing

### Case 2(Formalized):

### Model(XXXX),

### Y(2000),

### ActualCurrent(10),

### ElectricBreaker(ok),

### LightAlert(ok),

[symbol] LiquidLeakage

### New Problem

Problem: Pressure below 200
Model: VVV
Year: 2002
Actual current draw: 13.7 A
Status of Electric Service/breaker: OK
State of light alert: alert

### New Case(Formalized Body):

### Vehicle(VVV),

### Y(2002),

### ActualCurrent(13.7),

### ElectricBreaker(ok),

### LightAlert(alert),

Observations define a new problem
Not all feature values may be known
New problem=case without solution

### Steps of Algorithm 1:

Compare New Case with Case 1 (===: less important, ====very important)
Problem: Pressure below 285==80%==Pressure below 200
(formally: sim(f_{Pressure}^{NewCase},f_{Pressure}^{Case1})=0.8)
Model: VVV==40%==Model: XXX
Year: 2002==70%==Year: 1999
Current: 15.6V==90%==Current: 13.7V
State of breaker: OK==100%==State of breaker: OK
State of alert light: alert==100%==State of alert light: alert
Use weighted average for===(say: weight is 1) and ===(say: weight is 6)
Use similarity measures: “Pressure below 285, above 200” is 80% similar to “Pressure below 200”
Similarity by wted avg in the example=1/21 (6*0.8+1*0.4+1*0.7+6*0.9+6*1.0+6*1.0)=0.88
Repeat the same steps for all cases
Choose the best wted avg result

### II—Steps of Algorithm 2 (Adaptation and Reuse):

Suppose case 1 above became the best:
Replace in Case 1
Problem: “Pressure below 200” for “Pressure below 285, above 200”

### III—Storing New Cases (Case 3):

Problem: Pressure below 200
Vehicle: VVV
Year: 2002
Actual current draw: 13.7 A
Status of Electric Service/breaker: OK
State of light alert: alert
Diagnosis: Environmental Overheat
Repair: Lower air conditioning temperature

System Technical Specification

As mentioned above: The main objective of this system is to support the reduction of systems' down time through using the IoT and cloud based technology. The ultimate objective is to increase uptime and the availability of systems to customers and patients.

| Acronyms | Definitions |
|---|---|
| System | Cloud based real time monitoring system |
| MB | Main board is the main component of the System |
| | Hardware |
| SMB | Sensor Measurement Box which includes temperature, |
| | humidity and Air Quality sensors. |
| CMB | Current Measurement Box which includes earth current |
| | measurement and three phase current measurements. |
| HCMU | Helium Compressor monitoring Unit |
| GRMU | Ground Resistance Measurements Unit |
| ATMP | Auxiliary temperature sensors on main board |
| VMU | Voltage Measurement Unit |
| WFAU | Waveform Analysis Unit |
| RTC | Real time clock |
| WD | Watch Dog |
| (X)MB | Future sensors will be added |
| CAT6 cable | Very good performance network cable |
| RS-485 | Industrial protocol for serial interface |
| STM32 MC | The latest version of microcontrollers for ST company |

### Technical Description

System is a unique customizable/scalable device for real time monitoring based on cloud computing technology. It is designed to work as an advanced tool for data logging in any industrial environmental and medical applications. It monitors environmental conditions and critical parameters, suitable for any sophisticated systems, modalities, environment or facilities.

The cloud-based service ensures excellent performance, high data security, cost effectiveness, scalability that overcomes the traditional servers problems.

### System Components (FIG. 5)

| | | |
|---|---|---|
| Customizable hardware | Internet connection through | Cloud-baased service. Can |
| based on customer's needs | Ethernet technology | be accessed through |
| can monitor electrical and | connected to other gateway. | mobile, PC, Laptop and |
| environmental parameters | (3G, 2G, Wi-Fi, ADSL)* | tablet. |

*Internet connectivity provided by the customer.

### System Hardware

The MB (Main board) is the first and main component of the System Hardware. The MB has ARM Processor Cortex-M7 core with FPU (Floating point unit) and DSP (Digital signal processor) to do very complex tasks and sophisticated algorithms. The ARM Processor runs RTOS to ensure robustness of the firmware and handle very complex tasks. All components on the MB are industrial grade with the highest reliability. The MB includes embedded Industrial power supply with more than 500K guaranteed working hours.

The MB has flexible connectivity options to easy connect the System like Rs-485 industry standard interface and Ethernet interface. The MB includes RTC (Real Time clock) with small backup battery. RTC is configured to report time to the MB in very accurate timing (microseconds). The MB also is capable of auto clock synchronization to time-server UTC (Coordinated Universal Time) using NTP protocol. The MB has external battery supports up to eight hours in case of main power failure to save stored data and stay connected to cloud service. The MB Also includes hardware watchdog to ensure system is live and work will without any deadlocks.

The MB can measure the following parameters through VMU (Voltage Measurement Unit) and detects power quality events through WFAU (Waveform Analysis Unit).

| | |
|---|---|
| Three Phase Voltages. | Status of Main Input Power. |
| UPS Survival Status. | Ground to Neutral Voltage. |
| Voltage Imbalance. | Frequency Of Power Line. |

Power Events Detection According to IEEE classifications Of Power Quality (IEEE Std 1159-2009)

Which includes:

1- Voltage Sags.
2- Voltages Swells.
3- Interruption.
4- Over Voltage.
5- Under voltage.
6- Voltage Transients

The WFAU execute power quality algorithms which do the following functions:
Power quality events are detected using innovative algorithms according to 1159 IEEE standard.
A zero crossing detection technique is implemented to measure frequency.
Fast Fourier Transform is used in Transients detection.
Transients are detected in frequency range up to 4 kHz.
Sampling rate is 8 kSPS with accurate detection of any event.
True RMS calculation is calculated in a window for every cycle with a step of half cycle.
Start and End of event is captured and reported accurately At least 4 Cycles before and after.
All Sags, Swells, and Interruptions are detected.
Classification to the events is based on its period due to IEEE standard (Instantaneous, Momentary, Temporary, and Sustained).
Voltage Imbalance between 3-Phases is measured according to IEEE standard.

The MB has battery management system which supports the operation of System in case of electrical blackout or failure of power. The system also sends battery status periodical to ensure reliable Internet connection when AC power off. The management system is responsible for battery charging and monitors the battery health. The MB also has three Channels NTC temperature sensors which used as an Auxiliary sensor for System. The MB additionally has a special unit to measure earth resistance which is GRMU (Ground Resistance Measurements Unit). This unit measures the following parameters:
Loop Impedance (Line to Protective Earth L-PE).
Ground Resistance.
The second component of System Hardware is SMB (Sensor Measurement Box) which measures:
Temperature sensor
Humidity sensor
Air Quality sensor

All the three sensors are on the same printed board which makes the SMB an ideal solution for monitoring all environmental parameters. The SMB connected to MB through RS-485 industry standard interface which easing installation process and enhance communication reliability. The MB can support up to 256 units of SMB & CMB in any combination or other sensors types implemented in the future.

The third component of System Hardware is CMB (Current Measurement Box) that measures:
Three Phase Current.
Ground Current.

All the measurements process is non-invasive using clamp coils to ease the installation process and ensures the CMB has zero interference with other systems. The CMB connected to MB through RS-485 industry standard interface which easing installation process and enhance communication reliability.

The fourth component of System Hardware is Helium Compressor Monitoring Unit (HCMU). This unit detects the status of Helium compressor (ON/OFF) non-invasive without any interference with the equipment using the clamp coils like CMB. The HCMU connected to MB through RS-485 industry standard interface which easing installation process and enhance communication reliability.

With these four components System Hardware becomes a complete unique solution for power and grounding monitoring with environmental conditions monitoring and comprehensive tool that every field or service engineer needs it.

System Hardware Specification

### Main Board Specifications:

MB General Specifications

| | |
|---|---|
| Processor | ARM processor Cortex-M7 core with |
| | floating point unit |
| External Memory | 1 MB RAM |
| RTC | Real time clock is configured to report |
| | events with accurate time in milliseconds. |
| Time synchronization | Auto clock synchronization to time server |
| | UTC (Coordinated Universal Time) using |
| | NTP protocol |
| Watch Dog Monitor | External watch dog monitoring circuits |

VMU Specifications

| | |
|---|---|
| Number of channels | 7 Simultaneous Sampling(3 Before UPS, 3 |
| | After UPS, 1 For Neutral to Earth Voltage) |
| Sampling Rate | 8KSPS per channel |
| ADC Resolution | 24-Bits |
| Input Voltage Measurement Range | 0-480VRMS ± 15% (VRMS max 550 VAC) |
| Input Voltage Measurement Resolution | .1 VRMS |
| Input Voltage Measurement Accuracy | ±2% Max at full scale |
| Input Voltage Frequency | Auto Detection (40-70 Hz) |
| Neutral to Earth Voltage Measurement | 0-10VRMS Max |
| Range | |
| Voltage Imbalance Percentage | 0-100% |

### WFAU Specifications:

Power Events Detection According to IEEE classifications Of
Power Quality (IEEE Std 1159-2009).

| | |
|---|---|
| Types of events Detected | Voltage Sags, Voltages Swells, Interruption, |
| | Under voltage, Over Voltage, Voltage |
| | Transients. |
| Other Types of Events | Status of Main input Power, UPS Status, |
| | Phase sequence Detection* |
| Event Trigger | Voltage deviation of ½ cycle RMS voltage |
| | (≤90%) or ≥(110%) of set nominal. |
| Event Details Saving | Start and End of event is captured and |
| | reported accurately with 4 Cycles before and |
| | after. |
| Periodic RMS data Saving | Maximum, Minimum and average voltage |
| | recorded for each 2 minutes period. |

### GRMU Specifications:

| | |
|---|---|
| RE/Loop impedance Measurement Range | 0-200 Ω Max |
| RE/Loop impedance Measurement | 0.1 Ω |
| Resolution | |
| RE/Loop impedance Measurement | ±3% |
| Accuracy | |
| RE/Loop impedance (Phase to earth) Test | Maximum Test Current @ 220 V is 22 A |
| Condition | sinusoidal for 5 ms. |

Auxiliary Temperature Sensor Specifications

| | |
|---|---|
| Number of Sensors | 3 |
| Type of Sensor | NTC |
| Measurement Range | 0-80° C. |
| Measurement Resolution | 0.1° C. |
| Measurement Accuracy | ±0.5° C. |

Internal Power Supply Specifications

| | |
|---|---|
| Internal Power Supply input Voltage source | Powered from (L1-N) or (L1-L2) |
| Input Voltage Range | 85~264 VAC |
| Input Frequency | 47~440 Hz |
| Output Voltage | 12 VDC |
| RATED POWER | 30 Watt |
| SAFETY STANDARDS | UL60950-1, TUV EN60950-1 approved |
| MTBF | 593.3 Khrs min. MIL-HDBK-217 F. (25° C.) |
| External Input Power for system | 9 VDC (configuration only) |
| configuration | |

Battery Specifications

| | |
|---|---|
| Manufacture | Long (www.klb.com.tw) Model: WP10-6 |
| Technology | SLA |
| Capacity | 10 AH |
| Voltage | 6 VDC |
| System Battery Backup time | 8 Hours |
| Battery Full Charging time | 20 Hours (1% to −99%) |

Communication Specifications

| | |
|---|---|
| RS485 | Supported for internal modules (X)MB. |
| Ethernet | IEEE-802.3-2002-compliant (RJ45) |
| | To connect the MB to the Internet. |
| Network configuration | Powering external router with router reset |
| | periodically |

Environmental& Mechanical Specifications

| | |
|---|---|
| Indicators | Three LEDs (Running, Online, Alarm) |
| Enclosure | IP22 (Indoor use only). |
| Operating Temperature | 0-50° C. |
| Storage Temperature | 0-70° C. |
| Relative Humidity | 0-95% RH |
| Weight | 4.65 kg with battery |

SMB Specifications

SMB measures three parameters:
Temperature, Humidity and air quality.

Humidity Sensor Specifications

| | |
|---|---|
| Measurement Range | 0-100% RH |
| Measurement Resolution | 0.04% RH-12 bits |
| Measurement Accuracy | ±2% RH |

Temperature Sensor Specifications

| | |
|---|---|
| Measurement Range | −40-+125° C. |
| Measurement Resolution | 0.04° C.-12 bits |
| Measurement Accuracy | ±0.3° C. |

Air Quality Sensor Specifications

| | |
|---|---|
| Target Gas | Ammonia gas, toluene, hydrogen, smoke, |
| | sulfide, benzene series steam. |
| Detection Range | 10~1000 ppm (ammonia gas, toluene, |
| | hydrogen, smoke). |
| Sensitivity | Rs(in air)/Rs(in 400 ppm H2) ≥5 |
| Preheat Time | 48 Hours |

Interface & Powering of SMB specifications

| | |
|---|---|
| Interface to Main Board | RS-485 |
| Power | 12 volt - internally form Main Board |
| Indicators | One LED (online, Alarm) |

Environmental& Mechanical Specifications

| | |
|---|---|
| Enclosure | ABS Plastic |
| Operating Temperature | 0-50° C. |
| Storage Temperature | 0-70° C. |
| Relative Humidity | 0-95% RH |
| Weight | 100 gram |

CMB Specifications

CMB measures:
Three phase electrical current values and
earth current value. (Using current
coils - noninvasive).

Three Phase Current Measurements Specifications
(Current Coil Per phase) - Three Channels.

| | |
|---|---|
| Measurement Range | 0-80 A Max |
| Measurement Resolution | .1 A |
| Measurement Accuracy | 2% Max |
| Current coil Internal Hole Diameter | 16 MM |
| Current coil Dielectric Withstanding | 2.5 KV/1 mA/1 min |
| Voltage(Hi-pot) | |
| Current coil Impulse Withstand Voltage | 5 KV Peak |
| Current coil Insulation Resistance | DC500 V/100 MΩ min |
| Current coil Approx. Weight | 85 gm |

Earth Current Measurements Specifications - One Channel.

| | |
|---|---|
| Measurement Range | 0-1 A Max |
| Measurement Resolution | 1 mA |
| Measurement Accuracy | 2% Max |
| Alarm LED | ON if earth current value >250 mA |
| Current coil Internal Hole Diameter | 16 MM |
| Current coil Dielectric Withstanding | 2.5 KV/1 mA/1 min |
| Voltage(Hi-pot) | |
| Current coil Impulse Withstand Voltage | 5 KV Peak |
| Current coil Insulation Resistance | DC500 V/100 MΩ min |
| Current coil Approx. Weight | 85 gm |

Interface & Powering of CMB Specifications

| | |
|---|---|
| Interface to Main Board | RS-485 |
| Power | 12 volt - Internally form Main Board |
| Indicators | Two LEDS (online, Alarm) |

Environmental& Mechanical Specifications

| | |
|---|---|
| Enclosure | ABS Plastic |
| Operating Temperature | 0-50° C. |
| Storage Temperature | 0-70° C. |
| Relative Humidity | 0-95% RH |
| Weight | 400 gram |

HCMU Specifications

HCMU measures:
The efficacy of any pump or compressor.
(Using current coils - noninvasive).

Pump/Compressor Measurements Specifications
(Current Coil Per phase) - Three Channels.

| | |
|---|---|
| Measurement Range | 0-80 A Max |
| Measurement Resolution | .1 A |
| Measurement Accuracy | 2% Max |
| Threshold for detection | >1.5 A for All phases. |
| Alarm LED | ON if pump or compressor is off |
| Current Coils Specifications | The same specifications like CMB current |
| | coils |

Interface & Powering of HCMU Specifications

| | |
|---|---|
| Interface to Main Board | RS-485 |
| Power | 12 volt - Internally form Main Board |
| Indicators | Two LEDS (online, Alarm) |

Environmental& Mechanical Specifications

| | |
|---|---|
| Enclosure | ABS Plastic |
| Operating Temperature | 0-50° C. |
| Storage Temperature | 0-70° C. |
| Relative Humidity | 0-95% RH |
| Weight | 320 gram |

Power Quality Algorithms

Below is a description of the Power Quality algorithms used in above System and an illustration of electromagnetic phenomena variations. Then, measurements and power quality problems detected.

### Electromagnetic Phenomena Variations Overview

There are different categories of power system electromagnetic phenomena, and depending on the variations that happen, solving power quality problems is possible. The above described system identifies those variations using a sampling rate of 6000 Sps (samples per second). Efficient algorithms without losing any samples. Samples are captured and stored in suitable data structures.

The said system detects variations that may happen to the power system according to the IEEE standard (1159-2009). This standard is used by world's greatest manufacturers of metering and power quality analysis devices (Table 1).

### Power Quality Measurements and Events

Frequency.
Voltage RMS of every phase.
Min, Max, and Average RMS of voltage every 10 minutes.
Current RMS of every phase.
Voltage Imbalance between phases.
Sags, Swells and Interruptions with any period.
Min and Max RMS during the Sag, Swell, or Interruption.
Oscillatory Transients.

### Frequency Calculation

Frequency is calculated using a zero crossing detection algorithm. Samples come in sequence to the algorithm, the algorithm identifies a start of a cycle by detecting a transition from negative samples to positive samples, and identifies an end of a cycle by detecting the next transition from negative to positive.

Hysteresis is also implemented to avoid any wrong cycle recognition; A positive half cycle is not recognized as positive until samples have passed a certain threshold above zero line, and a negative cycle is not recognized as negative until samples have passed a certain threshold below zero line (FIG. 6).

The device counts the number of samples of this cycle. Knowing the sampling rate, Frequency can be easily calculated using number of samples.

### Voltage RMS of Every Phase

Samples are passed to the function that calculates RMS using the samples, so RMS that is calculated is True RMS. All samples of a cycle are squared, the sum is produced to calculate the average of the squares-mean-, at last the root of this average is found.

RMS=Samples per cycle2Number of samples

### Min, Max, and Average RMS

Minimum, Maximum, and Average RMS are determined across every passing 10-minutes. RMS is calculated for every passing cycle, and the step to calculate a cycle is half a cycle. Every RMS is put in comparison with the maximum RMS and the minimum RMS. If it is bigger than maximum, it is saved as Maximum and if it is smaller than minimum it is saved as Minimum, until 10 minutes passes. Then the maximum and minimum are reported to the cloud. Average also is calculated as follows: Number of RMS values that have passed over 10 minutes is calculated by a counter. Sum of all RMSs is calculated by adding every passing RMS to the Sum of all and after 10 minutes Sum is divided by Number of RMSs.

### RMS of Current for Every Phase

Three phases of Helium compressor are measured using current coils and if any phase is not consuming a minimum level of current, an alarm is raised that a compressor failure happened. The RMS is calculated also like the voltage RMS, but for the samples of Current.

### Voltage Imbalance Between Phases

Voltage imbalance between phases is calculated according to the IEEE standard (1159-2009) and based on ANSI C84.1-2006 [B2], which defines imbalance as the ratio of the maximum deviation of a voltage to the average voltage. RMS of every phase is calculated simultaneously and the average of these three values is calculated. A comparison of the three values is done to get the maximum deviation. That is, the modulus of the difference between every phase RMS is found as well as the average and biggest difference i.e. the maximum deviation is taken. The modulus is found by calculating the difference between RMS and the average. The biggest deviation is divided by the average to get imbalance. Imbalance is calculated in percent.

### Sags, Swells and Interruptions Events

An algorithm is used to detect sag, swell, interruption events according to STD (1159-2009). The algorithm takes samples and calculates RMS of a window of a cycle, the window moves by a step of half a cycle. Every result of RMS passes by the algorithm which first identifies the level of RMS i.e. Is it normal, over 110%, below 90%, or below 10%, and every level of these corresponds to normal, swell, sag, and interruption. After that, It detects if a transition from a level to level happened. If it is from normal to any other level, then it starts an event and four upcoming cycles are recorded and sent to the cloud so that, cycles themselves can be seen. If it is from any level to normal, then it is an end of an event and four last cycles are recorded and sent to the cloud (FIGS. 7 and 8). If it is from any level to any other level, then it is a start of a new event and an end of an old event. If the whole event happened within 8 cycles, the whole event is sent.

### Transients Detection Algorithms

The algorithm of transient detection uses FFT-Fourier Function Transformation- to find the components of the voltage signal and magnitude of these components. All magnitudes of components are scanned by the software to find any component of a frequency higher than 200 Hz that has a high magnitude. If there is any it detects a transient.

### DESCRIPTION OF THE DRAWINGS

The present invention may be better understood, and its numerous features and advantages made apparent to those skilled in the art by referencing the accompanying drawings.

FIG. 1 shows the logical components of the invention and their inter-relationships

FIG. 2 shows the way of work of Case Based Systems

FIG. 3 shows the equation used for the nearest evaluation function contained in the invention's CBS

FIG. 4 illustrates how to find a new case using CBS for the given example in the text

FIG. 5 shows the system hardware block diagram

FIG. 6 shows a frequency calculation sample

FIG. 7 shows the start of a power quality event

FIG. 8 shows the end of a power quality event

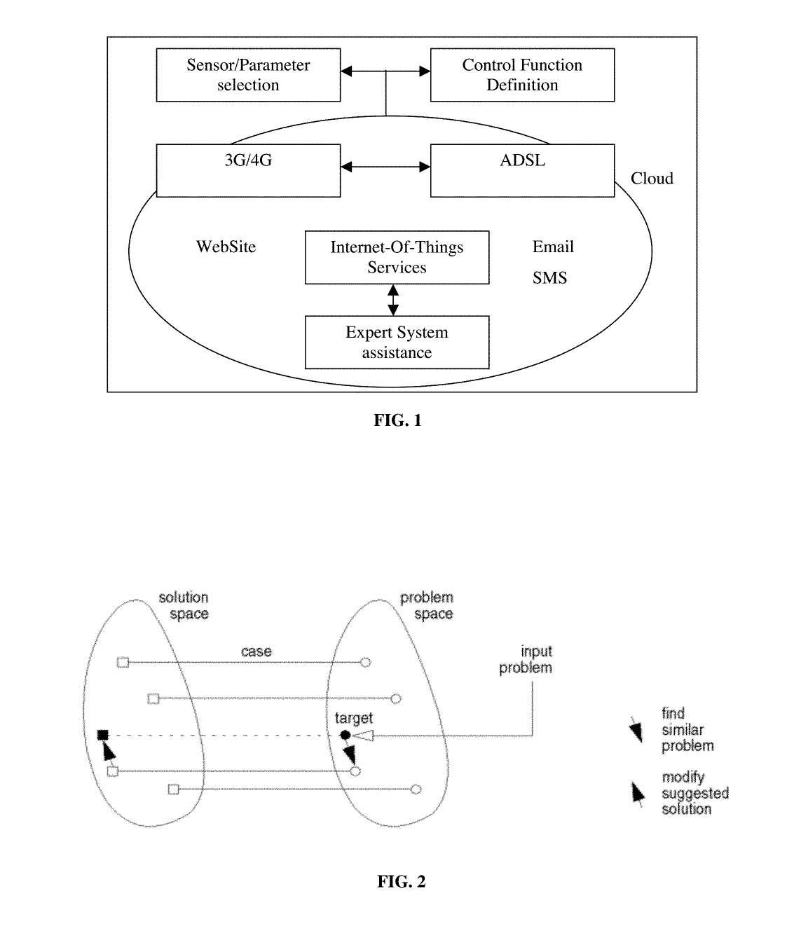

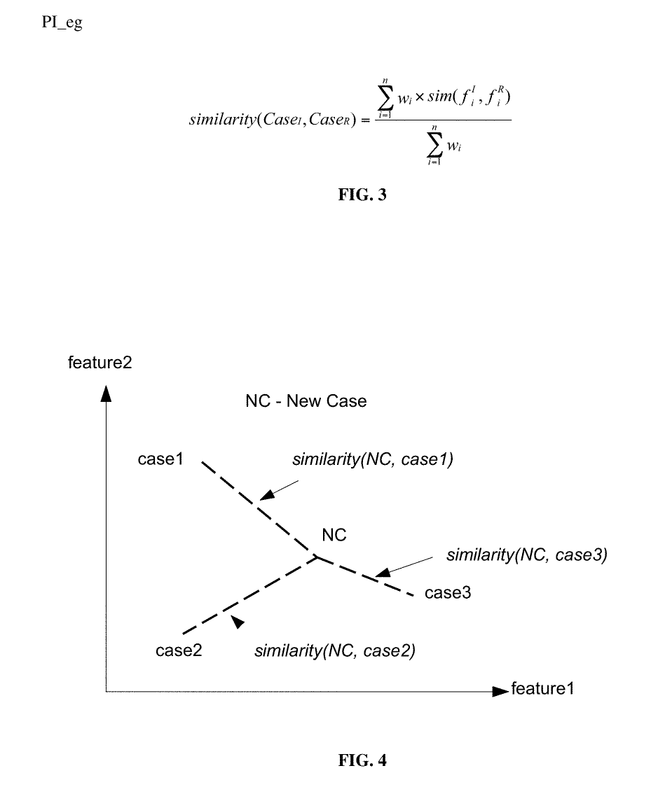

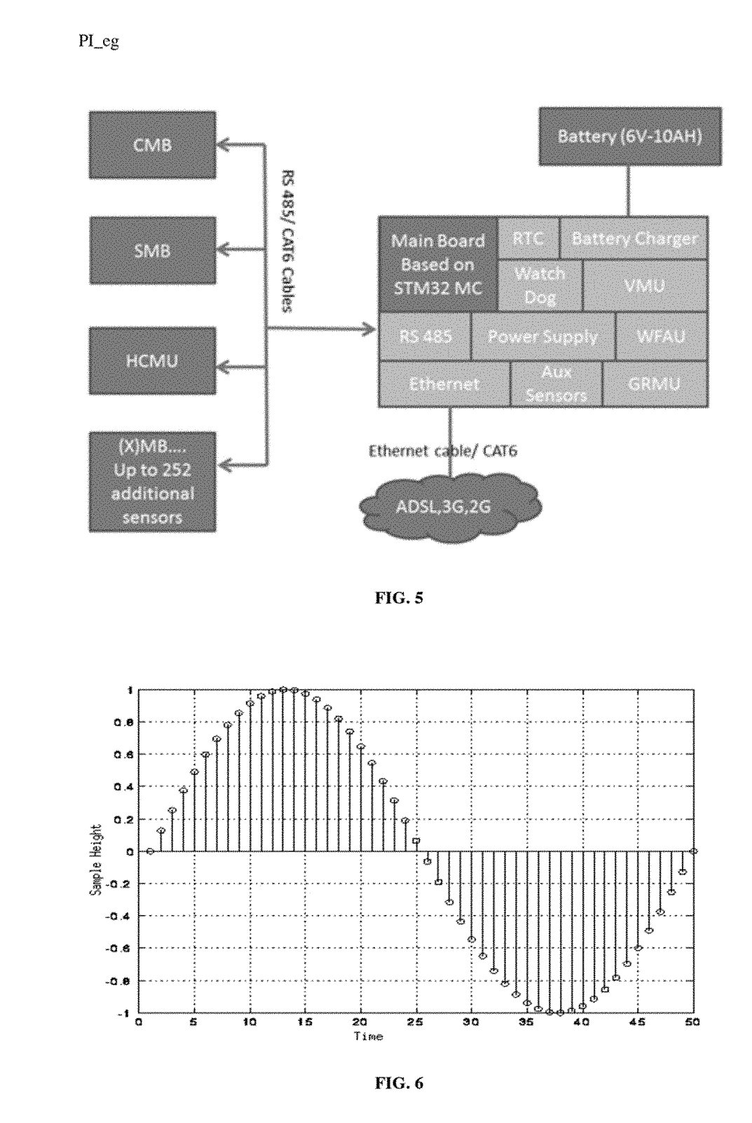

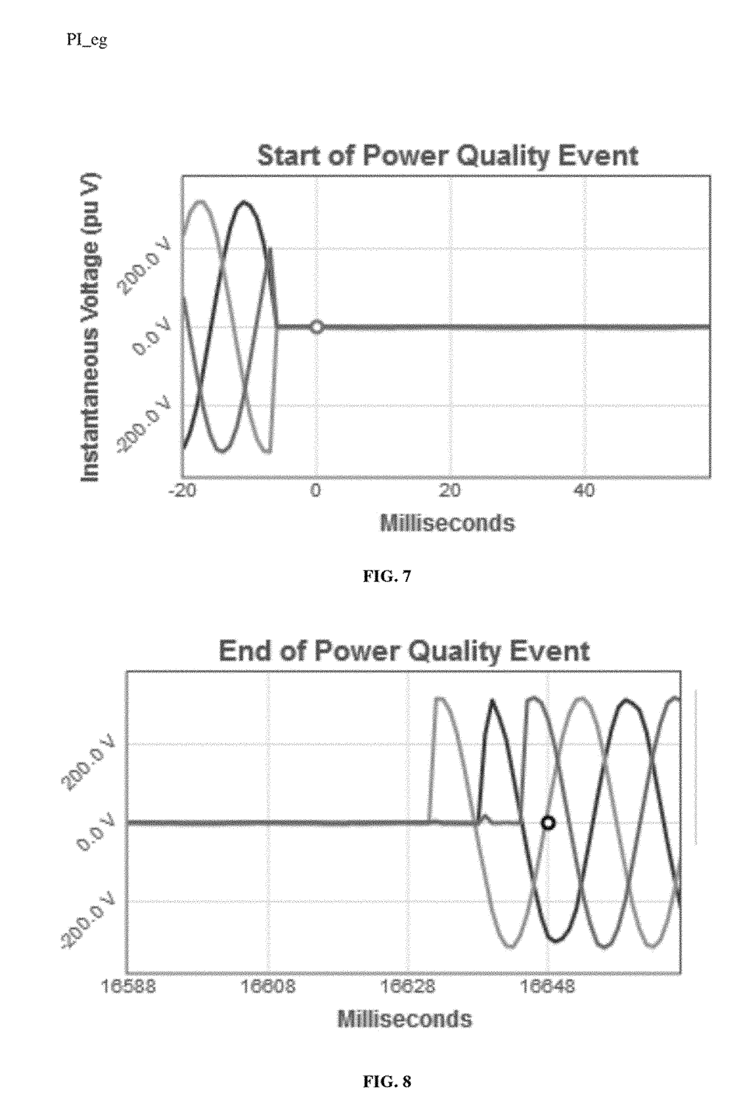

1. Apparatus, described in full technical detail in appendix I, used for preventive maintenance in the following industrial application environments:
1. Medical Equipment (MRI, CT, X-ray, PET-CT, etc)
2. Healthcare facilities& Blood banks
3. Pharmaceutical industries.
4. Food industries.
5. Environmental Data Acquisition and Studies
6. HVAC Systems.
7. Data Centers.
8. Smart buildings and smart cities.
which consists of: An embedded system with, an Ethernet interface, a USB interface, a group of status LEDs and input switches, a Current Measurement Unit (CMB), ambient temperature sensor, NTC temperature sensor, water temperature sensor, 3G Modem and Wi-Fi interface, backup battery and a group of general purpose inputs and outputs and whose main functionalities are logically interconnected as in FIG. 1, namely in such a way to ensure that:
External conditions and critical parameters are measured through the described hardware devices
Measured values are pushed to the Internet through 3G Modem, ADSL or Ethernet.
An Internet-of-things application monitors the parameters, predicts events and issues notifications through specially designed services
Those services use, in addition to customizable statistical tools, a CBR based expert system engine providing assistance in decision making using previous experience

2. Apparatus according to claim 1, characterized in that Ethernet, ADSL and 3G Modem services guaranteed constant, 24/7 connectivity of the device to the Internet

3. Apparatus according to claim 1, characterized in that router-reset functionality is powered through the main board

4. Apparatus according to claim 1, wherein Internet-of-things services are used to predict the status of given customizable parameters given location and other relevant information

5. Apparatus according to claim 1, wherein specialized weather forecasting modules are availed to handle extreme weather conditions and provide assistance for all necessary safety measures.

6. Apparatus according to claim 1, wherein loop impedance is measure in the below described way.

7. Apparatus according to claim 1, characterized in that an expert system engine is used to provide assistance in maintenance decisions

8. Apparatus according to claim 7, characterized in that the expert system engine uses CBR to provide solutions for new encountered maintenance cases

9. Apparatus according to claim 8, characterized in that the CBR based expert system engine uses Algorithms 1 and 2 to retrieve and adapt cases respectively
